(19) United States
(12) Patent Application Publication
(10) Pub. No.: US 2008/0230620 A1
(43) Pub. Date: Sep. 25, 2008

(54) Hot Water Supply Apparatus

(75) Inventor: Satoshi IDA, Maebashi-shi (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Gunma (JP)

(21) Appl. No.: 12/042,419

(22) Filed: Mar. 5, 2008

(30) Foreign Application Priority Data
Mar. 19, 2007 (JP) 2007-069951

(51) Int. Cl. B60H 1/02

(52) U.S. Cl. 237/2 A

(57) ABSTRACT

A hot water supply apparatus, capable of ensuring high safety in supplying hot water in case of power failure, which is configured as follows: When a voltage detected by a voltage sensor is a preset voltage or less, a mixing valve is operated so as to obtain a predetermined valve opening corresponding to a temperature detected by a temperature sensor. This permits the mixing valve to be driven by electric power when a voltage of a power supply drops, and the mixing valve to have such a valve opening that a temperature of hot water to be supplied to a user is a predetermined temperature or less, thus supplying hot water at a predetermined temperature or less to the user in case of power failure.

### BACKGROUND OF THE INVENTION

1. Field of the Invention

The present invention relates to a hot water supply apparatus for supplying hot water conditioned to a predetermined temperature by mixing hot water stored in a hot-water tank with water to be supplied.

2. Description of the Related Art

As this type of hot water supply apparatus, there has been conventionally known a hot water supply apparatus including: a heater for heating water to be supplied; a hot-water tank for storing hot water heated by the heater; and a mixing valve for obtaining hot water to be supplied by mixing hot water stored in the hot-water tank with water to be supplied.

However, conventional hot water supply apparatuses have the following problems: Use of hot water stored in the hot-water tank in case of power failure will cause impossible temperature control of hot water to be supplied, thus very hot water in the hot-water tank may be directly supplied and safety in using hot water cannot be ensured.

### BRIEF SUMMARY OF THE INVENTION

In view of the foregoing problems, it is an object of the present invention to provide a hot water supply apparatus capable of ensuring high safety in supplying hot water in case of power failure.

To attain the foregoing object, a hot water supply apparatus according to the present invention includes: a heater for heating water to be supplied; a hot-water tank for storing hot water heated by the heater; a mixing valve for mixing hot water stored in the hot-water tank with water to be supplied; a power supply as a power source; a voltage sensor for detecting a voltage of the power supply; a temperature sensor for detecting a temperature of hot water stored in the hot-water tank; and a controller for controlling operation of the mixing valve so as to obtain a predetermined valve opening corresponding to a temperature detected by the temperature sensor when a voltage detected by the voltage sensor is a predetermined voltage or less.

This permits detection of a drop in a voltage of a power supply in case of power failure as well as operation of the mixing valve so as to obtain a predetermined valve opening corresponding to a temperature of hot water stored in the hot-water tank, thus supplying hot water conditioned to the predetermined temperature or less in case of power failure. Accordingly, the hot water conditioned to the predetermined temperature or less can be supplied to a user in the case of power failure, thus attaining high safety in supplying hot water in case of power failure.

Further, to attain the foregoing object, a hot water supply apparatus according to the present invention includes: a heater for heating water to be supplied; a hot-water tank for storing hot water heated by the heater; a mixing valve for mixing hot water stored in the hot-water tank with water to be supplied; a hot-water pipe for circulating hot water flowing out of the hot-water tank; a flow switch for detecting presence of circulation of hot water in the hot-water pipe; a temperature sensor for detecting a temperature of hot water stored in the hot-water tank; and a controller for controlling operation of the mixing valve so as to obtain a predetermined valve opening corresponding to a temperature detected by the temperature sensor when the flow switch detects stopping of circulation of hot water in the hot-water pipe.

This permits the mixing valve to be operated so as to obtain a predetermined valve opening corresponding to a temperature of hot water stored in the hot-water tank, except in the case of ordinary hot water supply, thus supplying hot water conditioned to a predetermined temperature or less in case of power failure. Accordingly, hot water conditioned to the predetermined temperature or less can be supplied to a user in case of power failure, thus attaining high safety in supplying hot water in case of power failure.

The foregoing object, other objects, features and advantages of the present invention will become apparent from the following description of embodiments with reference to the accompanying drawings.

### BRIEF DESCRIPTION OF SEVERAL VIEWS OF THE DRAWINGS

FIG. 1 is a schematic configuration view of a hot water supply apparatus according to a first embodiment of the present invention;

FIG. 2 is a block diagram illustrating a control system;

FIG. 3 is a flowchart illustrating operations of a controller for operational control of a mixing valve when power supply voltage drops;

FIG. 4 is a block diagram illustrating a control system according to a second embodiment of the present invention; and

FIG. 5 is a flowchart illustrating an operation of a controller for operational control of a mixing valve.

### DETAILED DESCRIPTION OF THE INVENTION

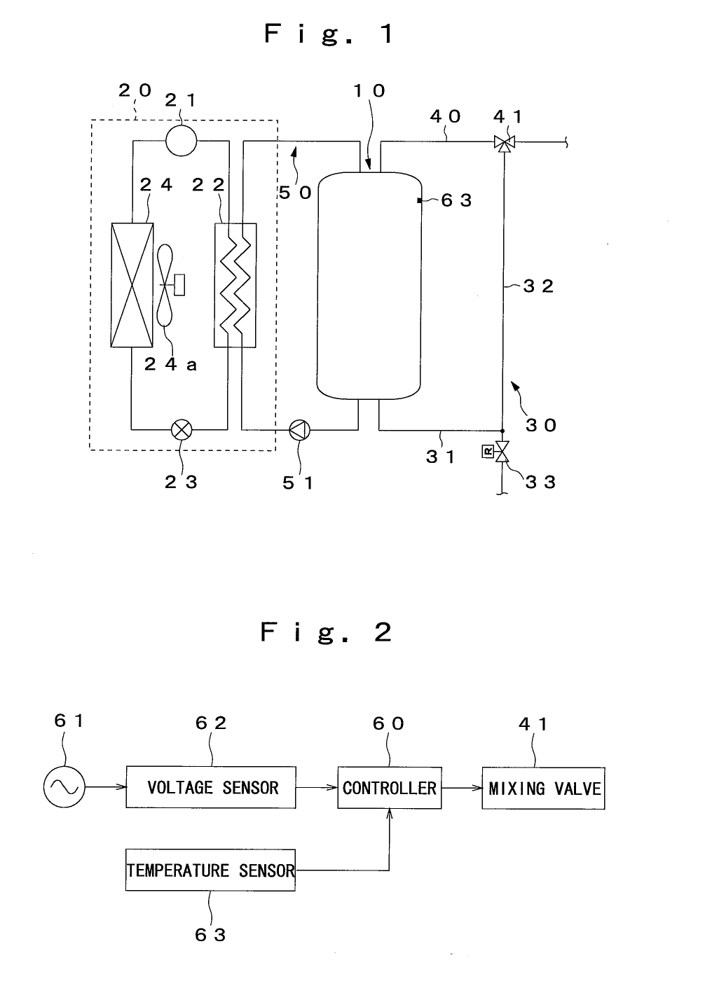

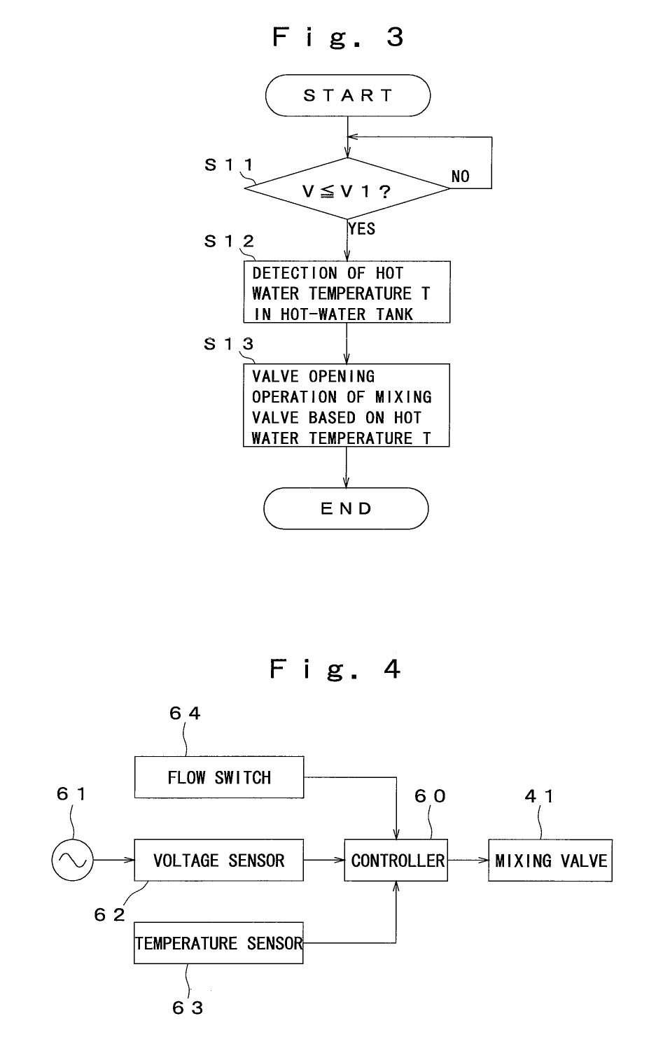

FIGS. 1 to 3 are views illustrating a first embodiment of the present invention.

The hot water supply apparatus includes: a hot-water tank 10 for storing water for hot water supply; a heat pump unit 20 for heating water stored in the hot-water tank 10; a water supply pipe 30 for supplying water to be supplied into the hot-water tank 10; a hot-water pipe 40 for supplying hot water in the hot-water tank 10 to a bathroom, a kitchen or the like; a circulation circuit 50 for returning, to the hot-water tank 10, water in the hot-water tank 10 heated by the heat pump unit 20; and a controller 60 for controlling an operating condition.

The hot-water tank 10 is constructed of a member made of stainless or the like and is formed into a cylindrical shape which has an upper end and a lower end closed and extends vertically. In addition, an appearance of the hot-water tank 10 is covered with a heat insulating material such as glass wool or foamed urethane, so that heat transfer between the inside and outside of the hot-water tank 10 is blocked.

The heat pump unit 20 includes an electric compressor 21, a gas cooler 22 as a heater, an expansion valve 23 and an evaporator 24, which are sequentially connected through a pipe made of copper, stainless or the like to form a refrigerant circuit. The refrigerant circuit is charged with carbon dioxide as refrigerant so that high-pressure side thereof becomes a supercritical state. Moreover, the evaporator 24 is mounted with a blower 24a for circulating air to be heat-exchanged with refrigerant.

The water supply pipe 30 has a first water supply pipe 31 connected with a lower portion of the hot-water tank 10 and a second water supply pipe 32 connected with a mixing valve described later. Additionally, at the water supply pipe 30 positioned on the upstream side of the first water supply pipe 31 and the second water supply pipe 32, there is provided a pressure reducing valve 33 for reducing the pressure of water supplied from a public water supply to a predetermined pressure for circulation.

The hot-water pipe 40 is connected with an upper portion of the hot-water tank 10, and a pressure of water flowing into a lower portion of the hot-water tank 10 from the first water supply pipe 31 permits hot water at the upper portion of the hot-water tank 10 to circulate. In addition, the hot-water pipe 40 is connected with the second water supply pipe 32 through an electric mixing valve 41, and hot water flowing out of the hot-water tank 10 is mixed with water flowing through the second water supply pipe 32 for circulation. Operating the mixing valve 41 can change a mixing ratio of hot water at the upper portion of the hot-water tank 10 to water in the second water supply pipe 32, thus supplying hot water conditioned to a desired temperature to a user.

The circulation circuit 50 is sequentially connected with the lower portion of the hot-water tank 10, a circulation pump 51, the gas cooler 22 and the upper portion of the hot-water tank 10 through copper or stainless pipe, and the circulation pump 51 permits water at the lower portion of the hot-water tank 10 to pass through the gas cooler 22 and flow into the upper portion of the hot-water tank 10.

The controller 60 is formed from a microcomputer and a memory thereof stores programs of operation of the heat pump unit 20 and the mixing valve 41. The controller 60 is connected with a voltage sensor 62 for detecting a power voltage supplied from a power supply 61 as a power source, a temperature sensor 63 for detecting a temperature of hot water stored in the upper portion of the hot-water tank 10 and the mixing valve 41. The controller 60 receives a signal detected by the voltage sensor 62 and transmits an output signal of a valve opening corresponding to a signal detected by the temperature sensor 63 to the mixing valve 41.

In performing a water heating operation by use of electric power such as midnight power with the hot water supply apparatus configured as described above, the compressor 21, the blower 24a and the circulation pump 51 are operated. This permits refrigerant discharged from the compressor 21 to pass through the gas cooler 22 and flow into the evaporator 24 via the expansion valve 23, and refrigerant flowing out of the evaporator 24 to be sucked into the compressor 21. Moreover, the water at the lower portion of the hot-water tank 10 is circulated in the circulation circuit 50 by the circulation pump 51, heated by heat exchange with refrigerant in the gas cooler 22 and stored in the upper portion of the hot-water tank 10. When the hot water at a preset temperature is stored in the hot-water tank 10 by a predetermined amount, the compressor 21, the blower 24a and the circulation pump 51 are stopped.

When a user operates a handle of a faucet in a bathroom or a kitchen, hot water at the upper portion of the hot-water tank 10 circulates in the hot-water pipe 40, is mixed with water circulating in the second water supply pipe 32 by the mixing valve 41 and is supplied to the user from the faucet. Consumption of hot water in the hot-water tank 10 allows water in the first water supply pipe 31 to flow into the hot-water tank 10, thus always maintaining the inside of the hot-water tank 10 at a full water level.

Referring now to a flowchart in FIG. 3, description will be made on an operation of the controller 60 with the mixing valve 41 when a voltage of electric power to be supplied drops in an event that power failure stops supply of electric power to the hot water supply apparatus.

When a voltage V detected by the voltage sensor 62 is a preset voltage V1 or less (step S11), a temperature T detected by the temperature sensor 63 is detected (step S12) and the mixing valve 41 is operated by the electric power before complete power failure so as to obtain a valve opening corresponding to the detected temperature T (step S13).

At this time, a temperature of hot water supplied to a user changes with a temperature of water circulating in the second water supply pipe 32 and, as the temperature of water circulating in the second water supply pipe 32 is higher, the temperature of hot water to be supplied becomes higher. When a temperature of tap water is high (for example, 25° C.) in summer or the like, a valve opening of the mixing valve 41 is set so that a temperature of hot water to be supplied is a predetermined temperature or less (for example, 43° C. or less), thus preventing supply of hot water at high temperature.

As described above, according to the hot water supply apparatus of the present embodiment, when a voltage V detected by the voltage sensor 62 is a preset voltage V1 or less, the mixing valve 41 is operated so as to obtain the predetermined valve opening corresponding to the temperature T detected by the temperature sensor 63. This permits the mixing valve 41 to be driven by the electric power obtained when a voltage of the power supply 61 drops and ensures such a valve opening of the mixing valve 41 that a temperature of hot water supplied to a user is the predetermined temperature or less, thus supplying the hot water at the predetermined temperature or less to the user in case of power failure for high safety in supplying hot water in case of power failure.

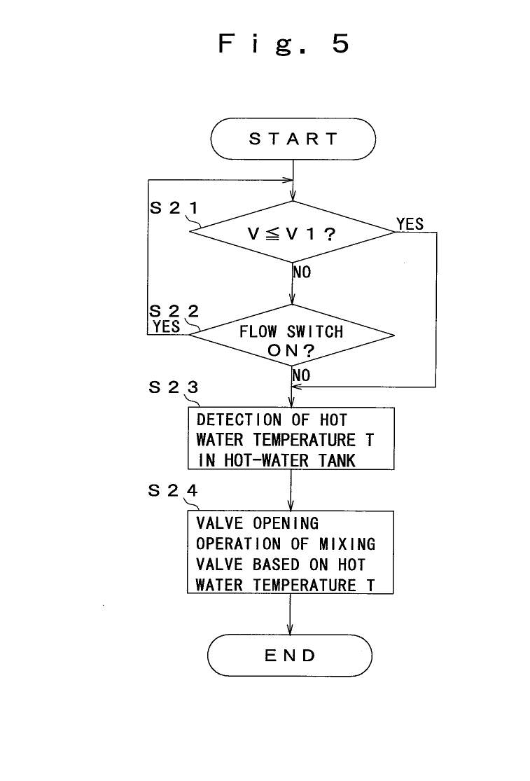

FIGS. 4 and 5 illustrate a second embodiment of the present invention. The same configuration portions as the above-described embodiment are indicated with the same symbol.

The hot water supply apparatus has a flow switch 64 on the hot-water pipe 40 positioned on the downstream side of the mixing valve 41. The flow switch 64, detecting presence of circulation of hot water in the hot-water pipe 40, is connected with the controller 60 and transmits a detection signal to the controller 60.

Referring now to a flowchart in FIG. 5, description will be made on an operation of the controller 60 with the mixing valve 41 in the hot water supply apparatus configured as described above.

If a voltage V detected by the voltage sensor 62 is the preset voltage V1 or less (step S21) or circulation of hot water is not detected by the flow switch 64 (step S22), a temperature T detected by the temperature sensor 63 is detected (step S23) and the mixing valve 41 is operated so as to obtain a valve opening corresponding to the detected temperature T (step S24).

This will not cause supply of hot water at a high temperature in supplying hot water to a user in case of power failure because the mixing valve 41 is preset to a valve opening thereof so that a temperature of hot water to be supplied to the user is a predetermined temperature or less, except during ordinary hot water supply. In case of power failure during ordinary hot water supply, the mixing valve 41 is operated by the electric power before complete power failure in the same way as the first embodiment, so that a temperature of the hot water to be supplied to the user is the predetermined temperature or less.

As described above, the hot water supply apparatus according to the present embodiment operates the mixing valve 41 so as to obtain a predetermined valve opening corresponding to a temperature T detected by the temperature sensor 63 when the flow switch 64 detects that circulation of hot water has stopped. Accordingly, even if electric power supply to the mixing valve 41 has stopped in case of power failure, the mixing valve 41 is preset so that a temperature of hot water to be supplied to a user is a predetermined temperature or less, so that hot water at the predetermined temperature or less can be supplied in case of power failure, thus attaining high safety in supplying hot water in case of power failure.

The second embodiment has described that the flow switch 64 detects presence of circulation of hot water in the hot-water pipe 40, but the presence of circulation of hot water in the hot-water pipe 40 may be detected by a flow rate sensor in place of the flow switch 64.

The embodiments described herein are illustrative and not restrictive. The scope of the present invention is defined by the appended claims, and all variations that fall within meets and bounds of the claims, or equivalence of such meets and bounds are therefore intended to be embraced by the claims.

1. A hot water supplying apparatus comprising:
a heater for heating water to be supplied;
a hot-water tank for storing hot water heated by the heater;
a mixing valve for mixing hot water stored in the hot-water tank with water to be supplied;
a power supply as a power source;
a voltage sensor for detecting a voltage of the power supply;
a temperature sensor for detecting a temperature of hot water stored in the hot-water tank; and
a controller for controlling operation of the mixing valve so as to obtain a predetermined valve opening corresponding to a temperature detected by the temperature sensor when a voltage detected by the voltage sensor is a predetermined voltage or less.

2. A hot water supplying apparatus comprising:
a heater for heating water to be supplied;
a hot-water tank for storing hot water heated by the heater;
a mixing valve for mixing hot water stored in the hot-water tank with water to be supplied;
a hot-water pipe for circulating hot water flowing out of the hot-water tank;
a flow switch for detecting presence of circulation of hot water in the hot-water pipe;
a temperature sensor for detecting a temperature of hot water stored in the hot-water tank; and
a controller for controlling operation of the mixing valve so as to obtain a predetermined valve opening corresponding to a temperature detected by the temperature sensor when the flow switch detects stopping of circulation of hot water in the hot-water pipe.
